(19) United States
(12) Patent Application Publication
(10) Pub. No.: US 2026/0177092 A1
(43) Pub. Date: Jun. 25, 2026

(54) ASSEMBLY DEVICE

(71) Applicant: A. Raymond et Cie, Grenoble (FR)

(72) Inventors: André Bégin-Drolet, Grenoble (FR); Jonathan Talbot, Grenoble (FR); Nicolas Petitfils, Grenoble (FR); Olivier Bizzini, Grenoble (FR); Alban Lengaigne, Grenoble (FR); Dominique Kroh, Grenoble (FR); Isabelle Rouzeval, Grenoble (FR)

(21) Appl. No.: 19/426,647

(22) Filed: Dec. 19, 2025

(30) Foreign Application Priority Data
Dec. 20, 2024 (FR) FR2414826

(51) Int. Cl. F16B 11/00

(52) U.S. Cl. CPC F16B 11/002

(57) ABSTRACT

An assembly device for assembling a first module and a second module includes: a first wedge configured to be secured to the first module and provided with a first face; a connection means configured to attach the first module to the second module; a second wedge provided with a second face; and a locking means configured to be inserted between the first face and the second face, and that under the effect of a bearing force exerted by one of the first face and the second face toward the other of the first face and the second face, deforms so as to prevent any movement of the locking means and the connection means in the directions of a plane defined by the first face.

### CROSS-REFERENCE TO RELATED APPLICATIONS

This application claims the benefit of the filing date of French Patent Application Serial No. FR2414826, filed Dec. 20, 2024, for “Assembly Device,” the disclosure of which is hereby incorporated herein in its entirety.

### TECHNICAL FIELD

The present disclosure relates to the field of assembly devices, in particular, to the field of module assembly devices. More particularly, the present disclosure concerns an assembly device that can be used for the modular construction of buildings.

### BACKGROUND

Prefabricated buildings generally comprise an assembly of modules, for example, of rectangular parallelepiped shape. These can be manufactured in a factory and transported to site for assembly in order to form a building. Notably, the use of modular constructions offers flexibility in terms of the intended purpose of the buildings and, in these regards, makes it possible to consider residential, professional and/or commercial buildings. Indeed, the factory-built modules can be designed to comprise the necessary fittings in order to meet the requirements associated with their intended use.

More particularly, it is possible to design modules that all have a standard general shape but whose equipment can vary based on need. In these regards, the modules can be fitted with worktops, cupboards, windows, doors, sanitary facilities, or washbasins.

Once on site, the modules can be arranged on top of and/or next to each other. In particular, attachment means can be used to secure the modules together. In particular, an attachment means can comprise a male connector arranged on a module, referred to as the first module, and a female connector arranged on another module, referred to as the second module. More particularly, the male connector is arranged on a corner, known as the male corner, of the first module while the female connector is arranged on a corner, known as the female corner, of the second module, the first corner and the second corner being selected to match when the second module is placed on the first module.

According to this arrangement, the male connector thus engages with the female connector and thus secures the first module to the second module. This engagement, without further consideration, may require a fine alignment of the male connector with the female connector. In order to alleviate this problem, the male connector can be mounted on the first module with lateral play allowing slight displacements of the male connector along the directions of the plane orthogonal to the extension direction of the male connector.

Thus, consideration of such play is particularly advantageous when a plurality of attachment means are used to secure the first module and the second modules together.

However, the existence of such play does not allow the modules to be securely attached together.

Thus, one aim of the present disclosure is to provide an assembly device that enables modules to be securely attached without play.

### BRIEF SUMMARY

The aim of the present disclosure is achieved by an assembly device for assembling two modules referred to, respectively, as a first module and a second module, the assembly device comprising:
a first wedge configured to be secured to the first module and provided with a first face;
a second wedge provided with a second face;
locking means configured to be inserted between the first face and the second face, and which under the effect of a bearing force exerted by one of the first face and of the second face toward the other of the first face and of the second face, deforms so as to prevent any movement of the locking means according to the directions of a plane defined by the first face.
According to one embodiment, the assembly device further comprises connection means configured to attach the first module to the second module, the locking means also being designed to prevent any movement of the connection means along the directions of a plane defined by the first face as soon as the locking means is deformed under the effect of a bearing force exerted by one of the first face and of the second face toward the other of the first face and of the second face.

According to one embodiment, the connection means comprises a male connector and a female connector, the male connector being provided with a base and a longitudinal member that extends in a direction of elongation from the base, and the female connector being configured to engage with the longitudinal member.

According to one embodiment, the locking means comprises a locking plate.

According to one embodiment, the locking plate comprises an opening, known as an intermediate opening, through which the longitudinal member can pass.

According to one embodiment, the first wedge and the second wedge are configured to engage with each other by interlocking, and whereby the deformation of the locking means results from the interlocking.

According to one embodiment, the second wedge comprises side walls between which the first wedge is designed to be nested.

According to one embodiment, the locking plate comprises side tabs that are configured to be folded against the side faces of the first wedge when the first wedge is interlocked in the second wedge by engaging with the side walls of the second wedge.

According to one embodiment, the locking plate comprises at least two precutting zones, each precutting zone comprises through-notches that are configured to allow a deformation of the precutting zone by way of punching, the first wedge comprises cavities, referred to as first cavities, emerging from the first face, advantageously cylindrical in shape, each first cavity being intended to match a precutting zone, advantageously, the through-notches form a cross.

According to one embodiment, the assembly device comprises punches configured to deform the precutting zones.

According to one embodiment, each punch comprises a pin, referred to as a first pin, supported by the second wedge and projecting with respect to the second face, each first pin having a size less than that of the first cavities.

According to one embodiment, each punch comprises a first washer and a second washer between which the locking plate is configured to be inserted, each first washer is housed in a first cavity, a pin, referred to as a second pin, is mounted on one or other of the first washer and the second washer, the pin being configured to pass through a through-opening, referred to as a locking opening, which is centered on the precutting zone of the locking plate, the locking opening having a diameter greater than that of the second pin, the other of the first washer and the second washer comprises an opening wherein the second pin is intended to be guided, each second washer is of a size less than that of the first cavities so as to allow the deformation of the precutting zones as soon as the second washers bear against the precutting zones.

According to one embodiment, the intermediate opening is configured for the longitudinal member to pass therethrough without play, advantageously, the intermediate opening conforms in terms of shapes and sizes with those of the longitudinal member, each first washer is mounted without play in the first cavity wherein it is housed.

According to one embodiment, the locking means comprises an additional plate supporting the second washers and inserted between the second wedge and the locking plate.

According to one embodiment, the additional plate comprises an opening, referred to as an additional opening, configured for the longitudinal member to pass therethrough, the additional opening is configured for the longitudinal member to pass therethrough without play, advantageously, the additional opening is conforms in terms of shapes and sizes with the longitudinal member, the intermediate opening has dimensions that are greater than those of the longitudinal member, each first washer is mounted with play in the first cavity wherein it is housed.

According to one embodiment, the locking means comprises, inserted between the second wedge and the locking plate, a deformation plate, the locking plate comprises two side fins that are configured to fold against two side faces of the first wedge, referred to as locking faces, which are opposite each other, the deformation plate being configured to cause the side fins to fold against the locking faces as soon as the second wedge presses the deformation plate against the locking plate.

According to one embodiment, the intermediate opening is configured for the longitudinal member to pass therethrough without play, advantageously the intermediate opening conforms in terms of shapes and sizes with those of the longitudinal member.

According to one embodiment, the deformation plate comprises a flat central section bearing against the locking plate, two side sections, which are oblique with respect to the deformation plate and each ending in an end section that is oriented in a direction opposite to the extension direction of the longitudinal member, each end section bearing against a side fin.

According to one embodiment, the male connector is held by the first wedge with play in the directions of the plane defined by the first face.

The present disclosure also relates to an assembly device for assembling two modules referred to, respectively, as a first module and second module, the assembly device comprising:
a first wedge that is configured to be secured to the first module and provided with a first face, the first wedge comprising cavities, referred to as first cavities, emerging from the first face;
a connection means configured to attach the first module to the second module;
a second wedge provided with a second face and comprises at least one pin, referred to as the first pin, projecting with respect to the second face, the at least one first pin having a size less than that of the first cavities;
a glue pocket arranged on the bottom of the first cavities, and that, under the effect of a bearing force exerted by the at least one first pin, when the first face and the second face are brought together, gives way and allows the glue contained therein to enter into the volume delimited by the first cavity in order to seal the first pin.
The present disclosure also relates to an assembly device for assembling two modules referred to, respectively, as a first module and second module, the assembly device comprising:
a first wedge configured to be secured to the first module and provided with a first face;
a connection means configured to attach the first module to the second module;
a second wedge provided with a second face;
a glue pocket on one or other of the first face and of the second face and that under the effect of a bearing force exerted when the first face and the second face are brought together, gives way and allows the glue contained therein to respond at the interface formed between the first face and the second face.

### BRIEF DESCRIPTION OF THE DRAWINGS

Other features and advantages of the present disclosure will emerge from the following detailed description of example embodiments of the present disclosure with reference to the appended figures, in which:

FIG. 1 is a schematic depiction of an assembly device according to a first embodiment of the present disclosure, notably, FIG. 1 shows the assembly device according to a perspective view;

FIG. 2 is a schematic depiction of the first wedge of the assembly device of FIG. 1, notably, FIG. 2 shows the first wedge according to a perspective view;

FIG. 3 is a schematic depiction of the second wedge of the assembly device of FIG. 1, notably, FIG. 3 shows the second wedge according to a perspective view and from a main face opposite the second face;

FIG. 4 is a schematic depiction of the second wedge of the assembly device of FIG. 1, notably, FIG. 4 shows the second wedge according to a perspective view and from the second face;

FIG. 5 is a schematic depiction of the locking plate of FIG. 1 and according to a perspective view;

FIG. 6 shows, according to a view according to a sectional plane perpendicular to the first face, the engagement of the first wedge in the second wedge;

FIG. 7 shows, according to a view according to a sectional plane perpendicular to the first face, the interlocking of the first wedge in the second wedge;

FIG. 8 is a schematic depiction, in perspective, of the locking plate according to a second embodiment of the present disclosure;

FIG. 9 is a schematic depiction, in perspective, of the first wedge according to a second embodiment of the present disclosure;

FIG. 10 is a schematic depiction, in perspective, of the second wedge according to a second embodiment of the present disclosure;

FIG. 11 is a schematic depiction of a second washer capable of being implemented in a third embodiment of the present disclosure;

FIG. 12 is a schematic depiction of a first washer capable of being implemented in a third embodiment of the present disclosure;

FIG. 13 is a schematic depiction of a locking plate inserted between two sets of first and second washers;

FIG. 14 is a schematic depiction of the locking plate according to the third embodiment of the present disclosure;

FIG. 15 is an illustration, relative to the third embodiment, of the locking plate resting on the front face, the two pins each being engaged in a locking opening;

FIG. 16 is an illustration of the assembly device according to the third embodiment and after deformation by stamping of the precutting zones in order to fix the locking plate and the male connector, this FIG. 16 notably shows the assembly device according to a sectional plane perpendicular to the front face and passing through the longitudinal member;

FIG. 17 is an illustration, relative to a fourth embodiment, of an additional plate partly forming the locking means;

FIG. 18 is an illustration of the assembly device according to the fourth embodiment and before deformation by stamping of the precutting zones, notably FIG. 18 shows notably the assembly device according to a sectional plane perpendicular to the front face and passing through the longitudinal member;

FIG. 19 is an illustration, relative to the fourth embodiment, of the locking plate;

FIG. 20 is an illustration, relative to the fourth embodiment, of the first wedge;

FIG. 21 is an illustration, relative to the fifth embodiment, of the locking plate;

FIG. 22 is an illustration, relative to the fifth embodiment, of the first wedge;

FIG. 23 is an illustration, relative to the fifth embodiment, of the deformation plate;

FIG. 24 is an illustration, relative to the fifth embodiment, of the assembly device (without the second wedge) before deformation of the side fins;

FIG. 25 is an illustration, relative to the fifth embodiment, of the assembly device after deformation of the side fins;

FIG. 26 is an illustration of a precutting zone on a deformation plate according to the sixth embodiment;

FIG. 27 is a depiction of the precutting zone of FIG. 26 through the first pin.

FIG. 28 is an illustration, relative to the seventh embodiment, of the assembly device being exemplified before deformation of the precutting zone and crushing of the glue bag;

FIG. 29 is an illustration, relative to the seventh embodiment, of the assembly device being exemplified after deformation of the precutting zone and crushing of the glue bag;

FIG. 30 is an illustration, relative to the eighth embodiment, of the assembly device being exemplified before crushing of the glue bag; and

FIG. 31 is an illustration, relative to the eighth embodiment, of the assembly device being exemplified after crushing of the glue bag.

### DETAILED DESCRIPTION

The present disclosure relates to an assembly device, and notably an assembly device capable for use in the building industry. More particularly, the present disclosure relates to an assembly device, which may comprise a male connector and a female connector wherein the male connector is configured to be engaged in a direction known as the engagement direction. In order to facilitate the engagement, and notably the alignment, of the male connector in the female connector, the male connector may have lateral play allowing slight translational movements of the latter in directions perpendicular to the engagement direction.

However, while this lateral play facilitates assembly, it does not mean that the assembly is firm. Thus, the present disclosure proposes an assembly device wherein the lateral play is neutralized once the male connector is engaged in the female connector.

Thus, the present disclosure relates to an assembly device for assembling two modules referred to, respectively, as a first module and a second module, the assembly device comprising:
a connection means configured to attach the first module to the second module;
a first wedge configured to be secured to the first module and provided with a first face;
a second wedge provided with a second face;
a locking means configured to be inserted between the first face and the second face, and that under the effect of a bearing force exerted by one of the first face and of the second face toward the other of the first face and of the second face, deforms so as to prevent any movement of the connection means and of the second wedge in the directions of a plane defined by the first face.
According to the present disclosure, a module can take any shape, and, in particular, is not limited to a rectangular parallelepiped. In particular, a module can represent a 3-dimensional object, a 2-dimensional object or a 1-dimensional object.

Advantageously, the connection means comprises a male connector and a female connector, the male connector being provided with a base and a longitudinal member that extends in a direction of elongation from the base, and the female connector being configured to engage with the longitudinal member.

Advantageously, the first wedge retains the male connector by its base, the first wedge comprising a first opening emerging through a first face of the first wedge, the longitudinal member passing through the first opening, so as to project with respect to the first face, the second wedge comprising a second opening emerging through a second face, and through which the longitudinal member is intended to be engaged in the female connector.

The assembly device is advantageously used for assembling, for example, by superposition or by juxtaposition, modules of considerable mass that need to be anchored to one another by way of a plurality of assembly devices.

By way of example, and without limiting the scope of the present disclosure to this aspect alone, the modules may comprise elementary constituent modules of a building.

Typically, these elementary modules can all have the same general shape, such as a rectangular parallelepiped.

According to the present disclosure, the longitudinal member can have a rectangular, square, triangular or circular cross-section.

“Cross-section” means a view along a sectional plane perpendicular to the direction of elongation of the longitudinal member.

Furthermore, it is also understood that engagement of the male connector with the female connector terminates with the securing of these latter with a fixed connection. In particular, the fixed connection may involve a latching means. However, this latter aspect is not such as to limit the scope of the present disclosure.

Thus, and advantageously, the male connector is held by the first wedge with play in the directions of the plane defined by the first face. As considered in the present disclosure, play allows slight displacements of the male connector in directions perpendicular to the direction of engagement of the longitudinal member in the female connector. These slight displacements can be of the order of a few millimeters, or even centimeters, or even less than 1.5 centimeters, advantageously less than 1 centimeter, even more advantageously less than 8 millimeters.

In order to compensate for, and more particularly to neutralize the play following the engagement of the male connector in the female connector, the assembly device may comprise a locking means. This locking means is notably configured so that, when it is deformed and clamped between the first face and the second face, it prevents any movement of the male connector (more particularly of the longitudinal member) in the directions of the plane perpendicular to the direction of engagement. The male connector is therefore fixed in a locked position.

Notably, and according to a particularly advantageous embodiment, the locking means comprises a plate, referred to as a locking plate, provided with an opening, referred to as an intermediate opening, through which the longitudinal member can pass.

According to a first embodiment, the first wedge and the second wedge are configured to engage with each other by interlocking, and whereby the deformation of the locking means results from the interlocking. Notably, the second wedge, generally rectangular parallelepipedal in shape, comprises four side walls between which the first wedge is designed to be interlocked.

Still according to this first embodiment, the locking plate may comprise side tabs that are configured to be folded against the side faces of the first wedge during the interlocking of the first wedge in the second wedge by engaging with the side walls of the second wedge.

Still according to this first embodiment, the intermediate opening may be dimensioned so that the longitudinal member can pass through it without play.

According to a second embodiment, the locking plate comprises at least two precutting zones, each precutting zone comprises through-notches that are configured to allow a deformation of the precutting zone by way of punching, the first wedge comprises cavities, referred to as first cavities, emerging from the first face, and, for example, cylindrical in shape, each first cavity being intended to match a precutting zone, advantageously, the through-notches form a cross.

Advantageously, the assembly device can comprise punches configured to deform the precutting zones. Notably, according to this second embodiment, each punch can comprise a pin, referred to as a first pin, supported by the second wedge and projecting with respect to the second face, each first pin having a size less than that of the first cavities.

The term “first pin having a size less than that of the first cavities” refers to a pin that, when it is housed in the first cavity, can be displaced laterally. By way of example, a first cavity can be cylindrical, and each first pin can have a diameter less than that of the first cavities.

According to the present disclosure, a precutting zone comprises through-notches formed in the locking plate. Notably, these through-notches thus form zones whose deformation is facilitated and controlled when they are subjected to a deformation force. In particular, the through-notches forming a precutting zone can be arranged to create zones capable of deformation by folding. To this end, a cross-shaped arrangement of through-notches can be advantageously considered.

The deformation of the precutting zones enables the male connector to be fixed. More particularly, the precutting zones are configured to be pressed into the first cavities when they are punched. This is achieved by pressing the locking plate firmly between one or other of the first face and of the second face thus fixing the locking plate in a locking position that prevents any movement of the male connector.

According to a third embodiment, the locking plate comprises at least two precutting zones, each precutting zone comprises through-notches that are configured to allow a deformation of the precutting zone by punching, the first wedge comprises cavities, referred to as first cavities, emerging from the first face (for example, cylindrical in shape), each first cavity being intended to match a precutting zone, advantageously, the through-notches form a cross.

Advantageously, the assembly device can comprise punches configured to deform the precutting zones.

More particularly, each punch can comprise a first washer and a second washer between which the locking plate is intended to be inserted, each first washer is housed in a first cavity, a pin, referred to as a second pin, is mounted on one or other of the first washer and the second washer, the pin being configured to pass through a through-opening, referred to as a locking opening, which is centered on the precutting zone of the locking plate, the locking opening having a diameter greater than that of the second pin, the other of the first washer and of the second washer comprises an opening in which the second pin is intended to be guided, each second washer is of a size less than that of the first cavities so as to allow the deformation of the precutting zones as soon as the second washers bear against the precutting zones.

Finally, and according to this third embodiment, the intermediate opening conforms in terms of shape and sizes with those of the longitudinal member while each first washer has a diameter equal to that of the first cavity wherein it is housed. More generally, the intermediate opening in question can be dimensioned so that the passage of the longitudinal member through the intermediate opening has no play.

Equivalent to the second embodiment, the precutting zones, once deformed, fix the locking plate in a locking position preventing any movement of the male connector.

According to a fourth embodiment, the locking plate comprises at least two precutting zones, each precutting zone comprises through-notches that are configured to allow a deformation of the precutting zone by punching, the first wedge comprises cavities, referred to as first cavities, emerging from the first face and cylindrical in shape, each first cavity being intended to match a precutting zone, advantageously, the through-notches form a cross.

Advantageously, the assembly device can comprise punches configured to deform the precutting zones.

More particularly, each punch can comprise a first washer and a second washer between which the locking plate is configured to be inserted, each first washer is housed in a first cavity, a pin, referred to as a second pin, is mounted on one or other of the first washer and the second washer, the pin being configured to pass through a through-opening, referred to as a locking opening, which is centered on the precutting zone of the locking plate, the locking opening having a diameter greater than that of the second pin, the other of the first washer and of the second washer comprises an opening wherein the second pin is intended to be guided, each second washer is of a size less than that of the first cavities so as to allow the deformation of the precutting zones as soon as the second washers bear against the precutting zones.

Finally, according to this fourth embodiment, the locking means can comprise an additional plate bearing the two washers and inserted between the second wedge and the locking plate, the additional pate comprises an opening, referred to as an additional opening, configured for the longitudinal member to pass therethrough, the additional opening is configured for the longitudinal member to pass therethrough without play, advantageously, the additional opening is consistent in terms of shapes and sizes with the longitudinal member, the intermediate opening has dimensions that are greater than that of the longitudinal member, each first washer is mounted with play in the first cavity wherein it is housed.

By way of example, the additional opening may conform in terms of shape and sizes with the longitudinal member, while the intermediate opening has dimensions greater than that of the longitudinal member.

According to a fifth embodiment, the locking means also comprises, inserted between the second wedge and the locking plate, a deformation plate, the locking plate comprises two side fins that are configured to fold against two side faces of the first wedge, referred to as locking faces that are opposite each other, the deformation plate being configured to cause the side fins to fold against the locking faces as soon as the second wedge presses the deformation plate against the locking plate. In particular, the intermediate opening conforms in terms of shape and sizes with the longitudinal member. According to the fifth embodiment, the deformation plate comprises a flat central section bearing against the locking plate, two side sections that are oblique with respect to the deformation plate and each ending in an end section that is oriented in a direction opposite to the direction of extension of the longitudinal member, each end section bearing against a side fin.

According to a sixth embodiment, the locking means comprises a locking plate. The locking plate comprises at least two precutting zones, each precutting zone comprises through-notches that are configured to allow a deformation of the precutting zone by punching, the first wedge comprises cavities, referred to as first cavities, emerging from the first face, advantageously cylindrical in shape, each first cavity being intended to match a precutting zone, advantageously, the through-notches form a cross. The assembly device comprises punches configured to deform the precutting zones. Each punch comprises a pin, referred to as a first pin, supported by the second wedge and projecting with respect to the second face, each first pin having a size less than that of the first cavities. Each first pin, comprises a recess, referred to as a first recess, and each first cavity comprises a circumferential groove, referred to as a first groove, the through-notches delimiting sections of the precutting zone, referred to as first sections, the connection means comprising the first groove, the first recess and the first sections, the first sections being shaped to, after punching, engage with the first groove and the first cavity so as to attach the first module to the second module. Each first section forms a triangle oriented toward the center of the deformation zone, the triangle comprising an end corner and two side corners, the two side corners being configured to be at least partly housed in the first groove after their deformation by punching, and the end corner being configured to be at least partly housed in the first recess after its deformation by punching.

The following is a description of each embodiment and of particular configurations.

### First Embodiment

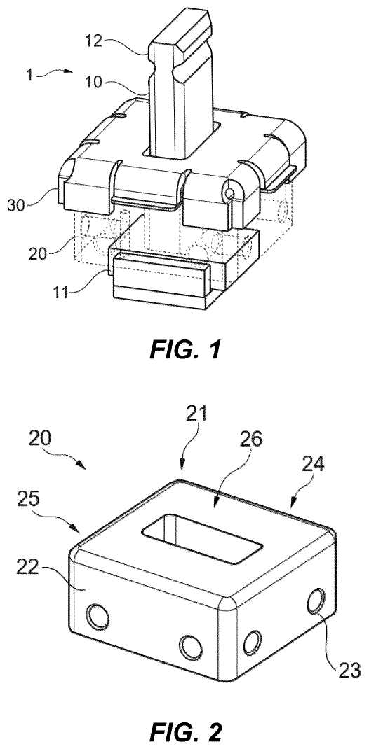

In FIG. 1, an assembly device 1 according to the first embodiment of the present disclosure can be seen.

The assembly device 1 comprises a male connector 10. In particular, the male connector 10 comprises a base 11, for example, a rectangular parallelepiped base 11, and a longitudinal member 12 that extends in an elongation direction from the base 11.

The assembly device 1 also comprises a female connector (not shown) and designed to cooperate with the longitudinal member 12. Notably, the cooperation between the male connector 10 and the female connector initially involves an engagement of the male connector in the female connector, and then, in a second step, fixed-locking of the longitudinal member in the female connector. The locking can comprise latching. Nevertheless, this aspect is given by way of example only and is not intended to limit the scope of the present disclosure.

The assembly device 1 also comprises a first wedge 20 (FIG. 2) designed to be secured to a first module.

The first wedge 20 depicted in FIG. 2 is notably rectangular parallelepipedal in shape. More particularly, the first wedge can comprise two main faces parallel to each other, one of which is designated the first face 21. The two main faces are also connected by side faces 22, 23, 24 and 25. For example, the side faces can be perpendicular to each other. In other words, the intersection of a plane parallel to the first face with the side faces can form a rectangle or even a square.

The first wedge 20 also comprises a through-opening, referred to as the first opening 26, emerging from either of the two main faces.

Furthermore, the first wedge 20 is configured to retain the male connector 10 by its base 11 and so that the longitudinal member 12 passes through the first opening 26 so as to project with respect to the first face. More particularly, the male connector 10 is held by the first wedge 20 by its base 11, the base 11 bearing against a main face of the first wedge 20 and opposite the first face 21.

In this respect, the male connector 10 can be held by the first wedge 20 with play in the directions of the plane defined by the first face 21.

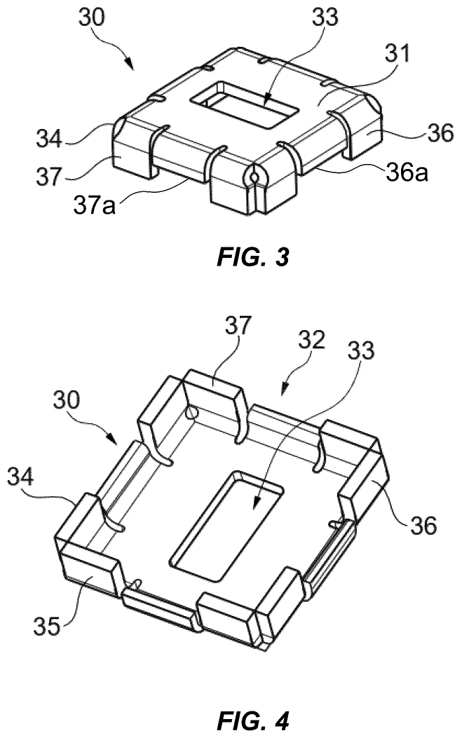

The assembly device 1 also comprises a second wedge 30 (FIG. 3 and FIG. 4). The second wedge 30 comprises a plate 31 delimited by two main faces parallel to each other, one of which is designated the second face 32. The second wedge 30 has a second opening 33 passing right through the plate 31. In particular, the second opening 33 is configured to allow the engagement of the longitudinal member 12, via the second face 32, in the female connector.

According to this first embodiment, the first wedge 20 and the second wedge 30 are configured to cooperate with each other by interlocking. In particular, the second wedge can be configured to enable the first wedge 20 to be interlocked in the second wedge 30. It is understood that the second wedge 30 can also be interlocked in the first wedge 20.

Thus, by way of example, the second wedge may be generally rectangular parallelepipedic in shape, and comprises four side walls 34, 35, 36 and 37 between which the first wedge 20 is designed to be interlocked. Each of the side walls 34, 35, 36 and 37 thus extends from an edge of the plate 31 to a free edge.

The assembly device 1 also comprises a locking means configured to be inserted between the first face 21 and the second face 32, and that, under the effect of a bearing force exerted by one of the first face 21 and the second face 32 toward the other of the first face 21 and the second face 32, deforms so as to prevent any movement of longitudinal member in the directions of a plane defined by the first face.

By way of example, the bearing force can be exerted by the weight of either the first module or the second module. Notably, a second module fitted with the second wedge can be positioned vertically above a first module fitted with the first wedge, so that the first face is opposite the second face. As it moves toward the first module, the second module, and notably the second wedge, exerts a deformation force on the locking means.

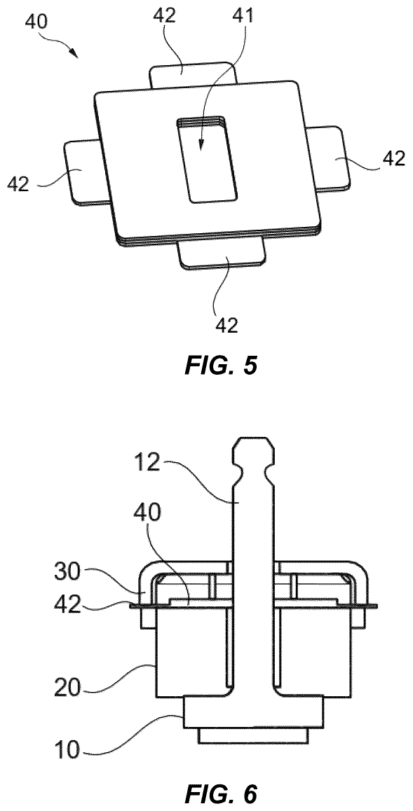

According to the first embodiment, the locking means comprises a plate, referred to as a locking plate 40 (FIG. 5), provided with an opening, referred to as an intermediate opening 41, through which the longitudinal member 12 is intended to pass. Notably, the intermediate opening 41 can be sized so that the longitudinal member passes through it without play. In particular, the opening 41 may have the same shape and the same dimensions as the cross-section of the longitudinal member 12.

According to this first embodiment, the locking plate 40 can comprise side tabs 42 that are configured to be folded against the side faces 22, 23, 24 and 25 of the first wedge 20 when the first wedge 20 is interlocked in the second wedge 30 by engaging with the side walls 34. 35, 36 and 37 of the second wedge 30.

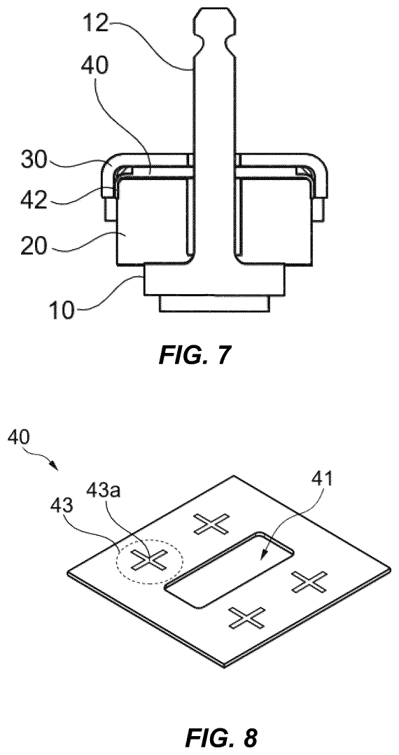

In this respect, FIG. 6 is an illustration of the assembly device 1 before the first wedge 20 is fully interlocked in the second wedge 30. In FIG. 6, it can be seen that the side tabs 42 remain in the plane of the locking plate 40. In FIG. 7, it can be observed that the first wedge is fully interlocked in the second wedge that leads to an immobilization of the locking plate 40. Indeed, this latter is immobilized between the first wedge and the second wedge, with the side tabs 42 folded against the side faces 22, 23, 24 and 25 of the first wedge 20. Notably, during the interlocking, each free edge of the side walls 34, 35, 36 and 37 exerts a force on the side tabs that are thus each folded back against a side face 22, 23, 24 and 25.

Also, and as exemplified in FIG. 3, each free edge of a side wall 34, 35, 36 and 37 may comprise a recessed notch 36a, 37a, matching the side tab 42. This last aspect notably enables the first wedge to be pre-engaged in the second wedge before folding the side tabs 42.

As the longitudinal member passes through the intermediate opening without lateral play, the immobilization of the locking plate leads to the immobilization of the longitudinal member.

### Second Embodiment

The present disclosure also covers a second embodiment that essentially reproduces the features of the first embodiment.

Nevertheless, this second embodiment differs from the first embodiment in that the locking plate has no side tabs but comprises at least two precutting zones.

More particularly, and as exemplified in FIG. 8, a precutting zone 43 comprises through-notches 43a formed in the locking plate. Notably, these through-notches 43a thus form zones whose deformation is facilitated and controlled when they are subjected to a deformation force. In particular, the through-notches 43a forming a precutting zone can be arranged to create zones capable of deformation by folding. To this end, a cross-shaped arrangement of through-notches can be advantageously considered.

Notably, the through-notches 43a can be configured to allow a deformation of the cutting zone by punching.

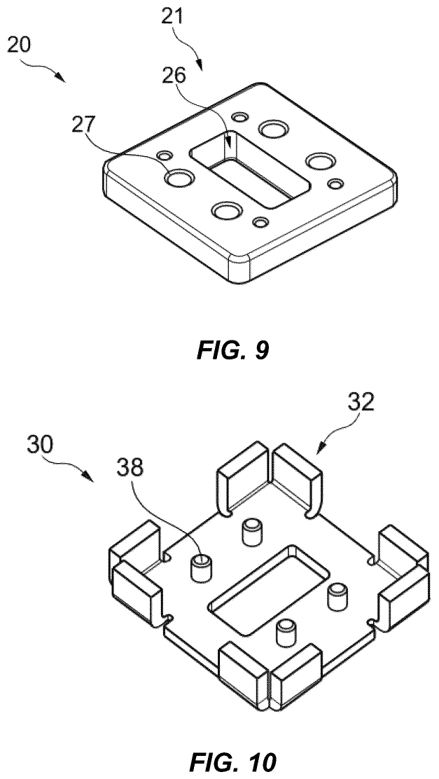

Still according to this second embodiment, the first wedge 20 (FIG. 9) comprises cavities, referred to as first cavities 27 emerging from the first face 21 and cylindrical in shape, each first cavity being intended to match a precutting zone 43.

The assembly device 1 also comprises punches configured to deform the precutting zones.

Notably, and as exemplified in FIG. 10, each punch comprises a pin, referred to as a first pin 38, supported by the second wedge 30 and projecting with respect to the second face, each first pin 38 having a diameter less than that of the first cavities 27.

During operation, the assembly device 1 according to this second embodiment allows the precutting zones in the first cavities 27 to be deformed/folded by the action of the first pins 38.

This deformation immobilizes the locking plate and male connector.

### Third embodiment

The present disclosure also covers a third embodiment that essentially reproduces the features of the second embodiment.

According to this third embodiment, the second wedge 30 may have no side walls.

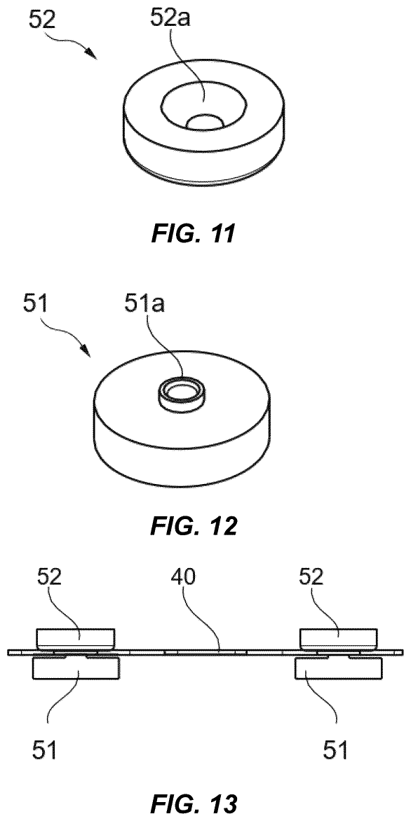

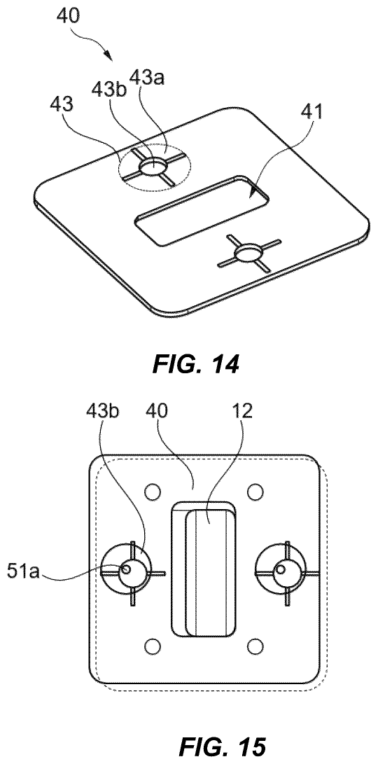

As exemplified in FIG. 11, each punch comprises a first washer 51 (FIG. 12) and a second washer 52 (FIG. 11) between which the locking plate (FIG. 13) is intended to be inserted.

Each first washer 51, housed in a first cavity, is surmounted by a pin 51a, referred to as the second pin 51a, configured to pass through a through-opening, referred to as the locking opening 43b, which is centered on the precutting zone 43 of the locking plate 40. In particular, the locking opening 43b has a diameter greater than that of the second pin 51a. This aspect notably enables the positioning of the locking plate to be adjusted prior to deformation of the precutting zones 43.

In this respect, FIG. 15 is an illustration of the locking plate 40 resting on the first face 21, with the second pins 51a each engaged in a locking opening 43b.

Still according to the third embodiment, the second washer 52 comprises an opening 52a wherein the second pin is intended to be guided, each second washer 52 is of a diameter less than that of the first cavities 27 so as to allow the deformation of the precutting zones 43 when the second washers 52 bear against the precutting zones 43.

According to this third embodiment, the intermediate opening 41 conforms in terms of shapes and sizes with those of the longitudinal member 12 while each first washer 51 has a diameter equal to that of the first cavity 27 wherein it is housed.

Equivalent to the second embodiment, the precutting zones, once deformed, fix the locking plate in a locking position preventing any movement of the male connector.

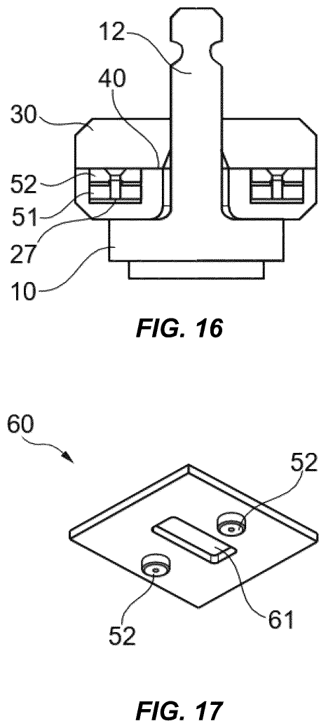

Notably, and as exemplified in FIG. 16, the deformation of the precutting zones 43 by the second washers 52 leads to a folding/stamping of the precutting zones 43 in the first cavities 27.

### Fourth Embodiment

The present disclosure also covers a fourth embodiment that essentially repeats the features of the third embodiment.

However, according to this fourth embodiment, the first washers 51 have a diameter less than the diameter of the first cavities 27. Furthermore, the intermediate opening 41 of the locking plate 40 allows the longitudinal member 12 to pass through with play.

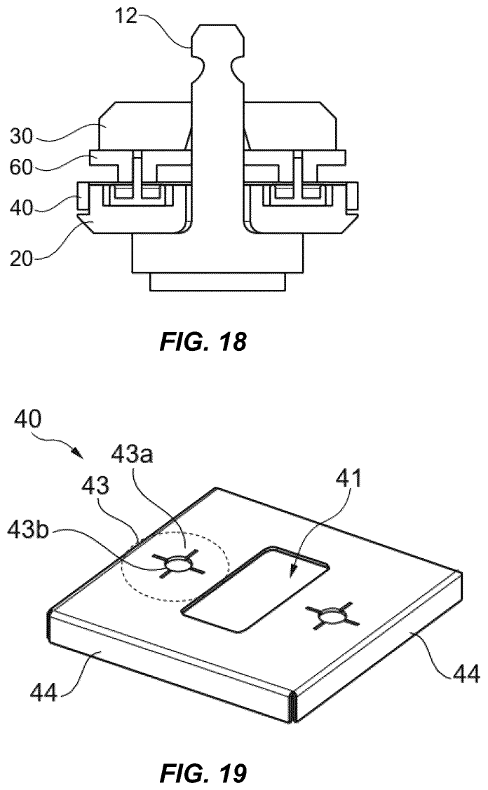

According to this fourth embodiment, the locking means comprises an additional plate 60 (FIG. 17) carrying the second washers 52 on one of its faces. Notably, and as exemplified in FIG. 18, the additional plate is configured to be inserted between the second wedge 30 and the locking plate 40.

The additional plate 60 comprises an opening, referred to as an additional opening 61, through which the longitudinal member 12 can pass without play. Notably, the additional opening 61 can conform in terms of shapes and sizes to the longitudinal member 12, while the intermediate opening 26 has dimensions greater than that of the longitudinal member, each first washer 51 being, moreover, of a diameter less than that of the first cavity wherein it is housed.

According to this fourth embodiment, the deformation of the precutting zones by a force exerted by the additional plate 60 immobilizes the latter and consequently also immobilizes the longitudinal member 12.

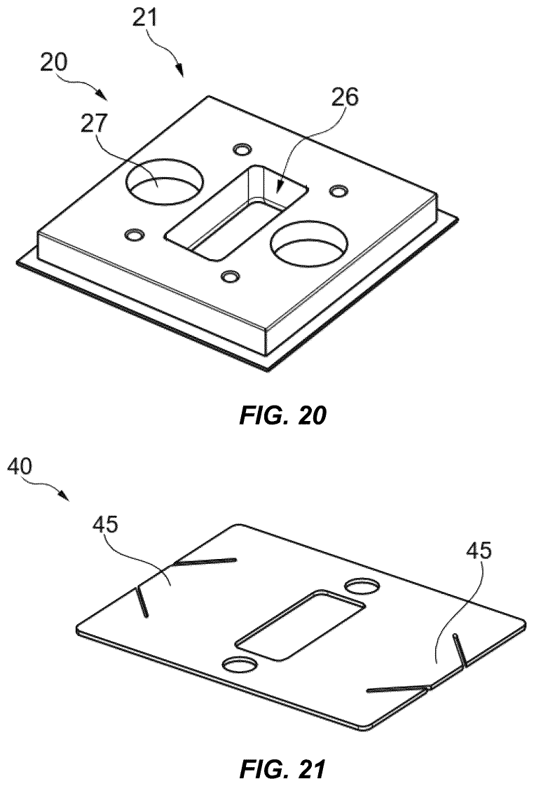

The locking plate 40 (FIG. 20) may also comprise side walls 44 configured to allow the first wedge 20 to be interlocked between the side walls 44.

### Fifth Embodiment

The present disclosure also covers a fifth embodiment that essentially repeats the features of the first embodiment.

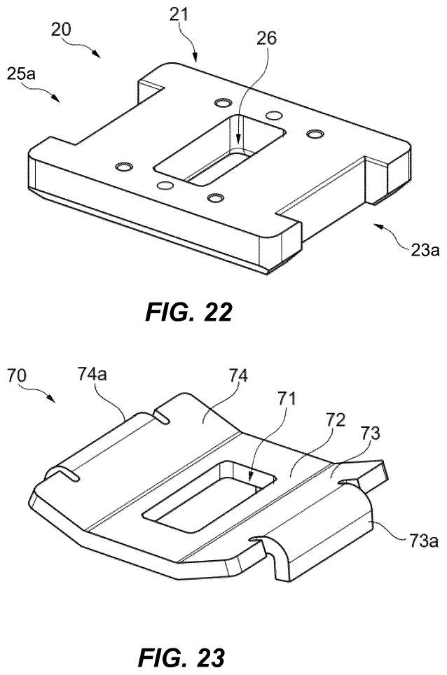

According to this fifth embodiment, the second wedge 30 (FIG. 25) may have no side walls. The locking plate 40 (FIG. 21) comprises two side fins 45 configured to fold against two side faces 23 and 25, referred to as locking faces that are opposite each other, of the first wedge 20. Notably, each locking face 23 and 25 (FIG. 22) may comprise a notch 23a and 25a into which one or other of the side fins 45 is designed to fold.

Inserted between the second wedge 30 and the locking plate 40, the locking means also comprises a deformation plate 70 (FIG. 23). The deformation plate is notably configured to cause the side fins to fold against the locking faces when the second wedge presses the deformation plate against the locking plate.

The intermediate opening conforms in terms of shapes and sizes with those of the longitudinal member.

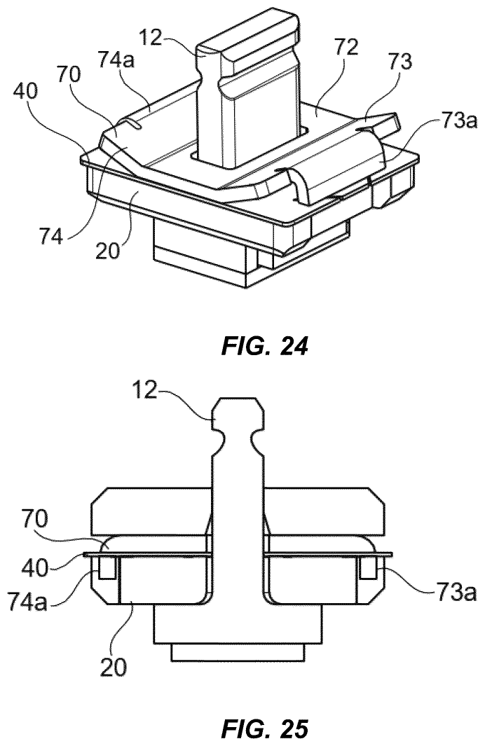

According to the fifth embodiment, the deformation plate 70 comprises a central through-opening 71 supported by a flat central section 72 bearing against the locking plate 40 (FIG. 23, FIG. 24 and FIG. 25), two side sections 73 and 74 that are oblique with respect to the deformation plate each ending in an end section 73a and 74a that is oriented in a direction opposite to the extension direction of the longitudinal member 12, each end section bearing against a side fin. Also, when a force is applied to flatten the deformation plate by the action of the second wedge, each of the side sections 73 and 74 folds the side fins in the notches 23a and 25a. At the end of this deformation, the locking plate 40 is fixed. Also, as the intermediate opening of the locking plate conforms in terms of shapes and sizes with those of the longitudinal member, the latter is also fixed.

### Sixth Embodiment

The present disclosure also covers a sixth embodiment that essentially repeats the features of the second embodiment.

This sixth embodiment differs from the second embodiment in its connection means.

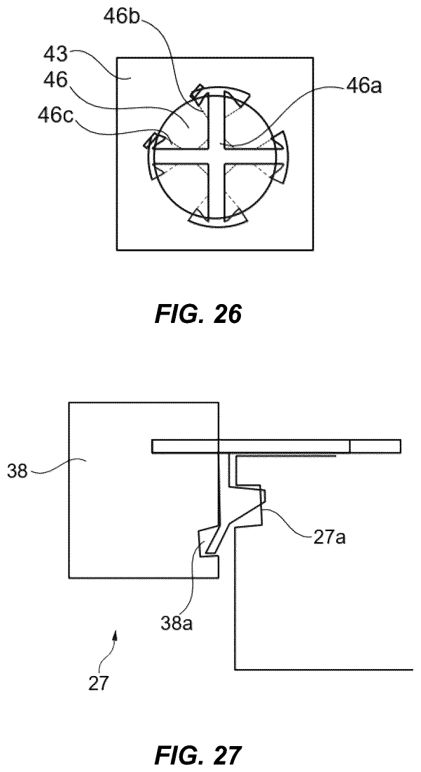

FIG. 26 is an illustration of a precutting zone 43 on a deformation plate, while FIG. 27 is a depiction of the precutting zone by the first pin 38.

According to this sixth embodiment, each first shaped pin 38 comprises a recess, referred to as the first recess 38a.

Each first cavity 27 comprises a circumferential groove 27a, referred to as a first groove 27a.

The through-notches delimit sections of the precutting zone 43, referred to as first sections 46, shaped to cooperate with the first groove and the first cavity after punching, so as to attach the first module to the second module.

According to this sixth embodiment, the connection means comprises the first groove 27a, the first recess 38a and the first sections 46.

Particularly advantageously, each first section 46 forms a triangle oriented toward the center of the deformation zone, the triangle comprising an end corner 46a (oriented toward the center of the precutting zone) and two side corners 46b and 46c, the two side corners 46b and 46c being configured to be at least partly housed in the first groove 27a after their deformation by punching, and the end corner 46a being configured to be at least partly housed in the first recess 38a after its deformation by punching (FIG. 27).

Thus, during punching, the first pin 38 deforms each of the first sections 46 and folds them inside the first cavity 27. At the end of this deformation, the end corner 46a abuts in the first recess 38a while the side corners abut in the first recess 38a, thus preventing any withdrawal of the first pin. The first wedge and the second wedge are thus secured together. The locking plate 40, for its part, is fixed and therefore deprived of all movement in the directions of a plane defined by the first face.

### Seventh Embodiment

The present disclosure also covers a seventh embodiment that essentially repeats the features of the third embodiment.

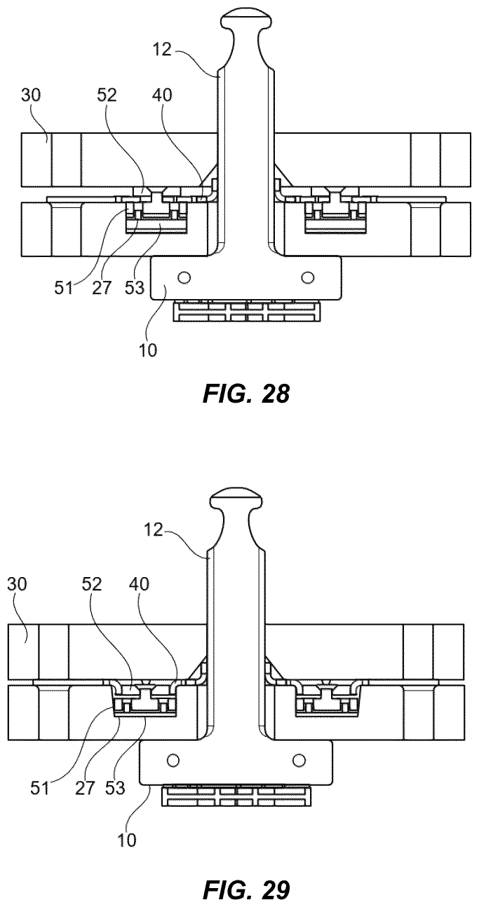

This seventh embodiment implements a glue bag that is placed between the bottom of the first cavity 27 and the first washer 51 (FIG. 28). During operation, when the precutting zones are deformed, a force is also exerted on the glue bag 53 that gives way and allows the glue contained therein to spread throughout the volume of the first cavity thus sealing the deformed precutting zone (FIG. 29).

### Eighth Embodiment

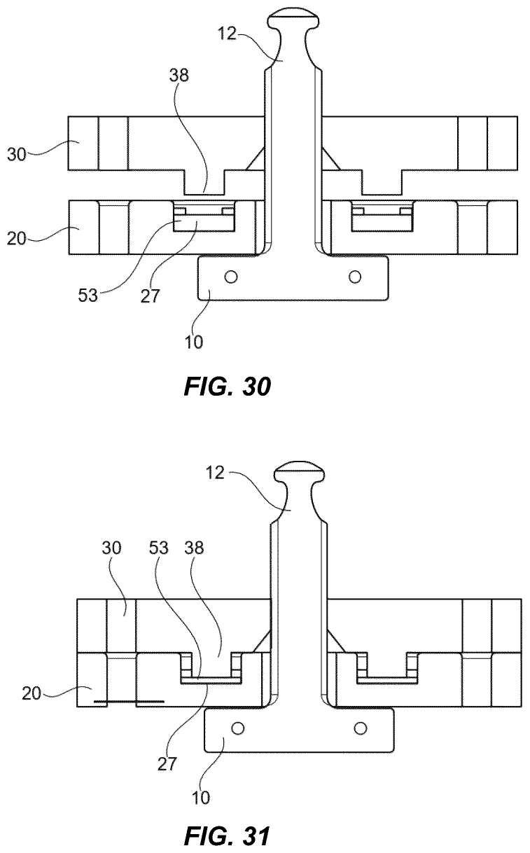

The present disclosure also covers an eighth embodiment that essentially repeats the features of the seventh embodiment. However, in this embodiment, the assembly device lacks a locking plate and locking means (FIG. 30).

The assembly device also lacks the first washer and the second washer. These are replaced by the pin 38 (also considered in the second embodiment). As in the seventh embodiment, the assembly device comprises a glue bag 53 arranged at the bottom of the first cavity 27.

During operation, when the first wedge 20 and the second wedge 30 are brought together, the first pin crushes the glue bag. Following this crushing, the glue bag gives way so that the glue spreads throughout the volume of the first cavity 27 (FIG. 31), and thus seals the first pin 38.

The glue may comprise at least one of the elements selected from: a hardening resin, an epoxy glue, a polyester glue or a polyurethane glue.

The present disclosure also relates to a building made up of a plurality of rectangular parallelepiped modules, the modules being assembled and secured together by way of assembly devices in accordance with the principles set out in the present disclosure.

Of course, the present disclosure is not limited to the described embodiments and variant embodiments may be envisaged without departing from the scope of the invention as defined by the claims.

What is claimed is:

1. An assembly device for assembling a first module and a second module, the assembly device comprising:
a first wedge configured to be secured to the first module and provided with a first face;
a connection means configured to attach the first module to the second module;
a second wedge provided with a second face; and
a locking means that is configured to be inserted between the first face and the second face, and that, under the effect of a bearing force exerted by one of the first face and the second face toward the other of the first face and the second face, deforms so as to prevent any movement of the locking means and the connection means in the directions of a plane defined by the first face.

2. The assembly device of claim 1, wherein the locking means comprises a locking plate.

3. The assembly device of claim 1, wherein the connection means comprises a male connector and a female connector, the male connector having a base and a longitudinal member that extends in a direction of elongation from the base, and the female connector being configured to engage with the longitudinal member.

4. The assembly device of claim 3, wherein the locking means comprises a locking plate, the locking plate comprising an intermediate opening intended for the longitudinal member to pass therethrough.

5. The assembly device of claim 3, wherein the first wedge and the second wedge are configured to engage with each other by interlocking, and whereby the deformation of the locking means results from the interlocking.

6. The assembly device of claim 5, wherein the second wedge comprises side walls between which the first wedge is intended to be interlocked.

7. The assembly device of claim 6, wherein the locking plate comprises side tabs that are configured to be folded against the side faces of the first wedge when the first wedge is slotted into the second wedge by engaging with the side walls of the second wedge.

8. The assembly device of claim 2, wherein the locking plate comprises at least two precutting zones, each precutting zone comprises through-notches that are configured to allow a deformation of the precutting zone by way of punching, the first wedge comprises first cavities emerging from the first face, each first cavity being intended to be in correspondence with a precutting zone.

9. The assembly device of claim 8, further comprising punches that are configured to deform the precutting zones.

10. The assembly device of claim 9, wherein each punch comprises a first pin supported by the second wedge and projecting with respect to the second face, each first pin having a size less than that of the first cavities.

11. The assembly device of claim 9, wherein each punch comprises a first washer and a second washer between which the locking plate is configured to be inserted, each first washer is housed in a first cavity, a second pin being mounted on one or other of the first washer and the second washer, the second pin being configured to pass through a locking opening, which is centered on the precutting zone of the locking plate, the locking opening having a diameter greater than that of the second pin, the other of the first washer and the second washer comprises an opening wherein the second pin is intended to be guided, each second washer being of a size less than that of the first cavities so as to allow the deformation of the precutting zones as soon as the second washers bear against the precutting zones.

12. The assembly device of claim 4, wherein the intermediate opening is configured for the longitudinal member to pass therethrough without play, each first washer being mounted without play in the first cavity in which the respective first washer is housed.

13. The assembly device of claim 11, wherein the locking means comprises an additional plate supporting the second washers and inserted between the second wedge and the locking plate.

14. The device of claim 11, wherein the connection means comprises a male connector and a female connector, the male connector having a base and a longitudinal member that extends in a direction of elongation from the base, and the female connector being configured to engage with the longitudinal member, and wherein the additional plate comprises an additional opening configured for the longitudinal member to pass therethrough, the additional opening being configured for the longitudinal member to pass therethrough without play, the intermediate opening having dimensions that are greater than those of the longitudinal member, each first washer being mounted with play in the first cavity in which the respective first washer is housed.

15. The assembly device of claim 2, wherein the locking means comprises, inserted between the second wedge and the locking plate, a deformation plate, the locking plate comprising two side fins that are configured to fold against two side locking faces of the first wedge, which are opposite each other, the deformation plate being configured to cause the side fins to fold against the locking faces as soon as the second wedge presses the deformation plate against the locking plate.

16. The assembly device of claim 15, wherein the locking means comprises a locking plate, the locking plate comprising an intermediate opening intended for the longitudinal member to pass therethrough, and wherein the intermediate opening is configured for the longitudinal member to pass therethrough without play.

17. The assembly device of claim 15, wherein the deformation plate comprises a flat central section bearing against the locking plate, two side sections that are oblique with respect to the deformation plate each ending in an end section that is oriented in a direction opposite to the extension direction of the longitudinal member, each end section bearing against a side fin.

18. The assembly device of claim 10, wherein each first pin comprises a first recess, and each first cavity comprises a circumferential first groove, the through-notches delimiting first sections of the precutting zone, the connection means comprising the first groove, the first recess and the first sections, the first sections being shaped to, after punching, engage with the first groove and the first cavity so as to attach the first module to the second module.

19. The assembly device of claim 18, wherein each first section forms a triangle oriented toward the center of the deformation zone, the triangle comprising an end corner and two side corners, the two side corners being configured to be at least partly housed in the first groove after their deformation by punching, and the end corner being configured to be at least partly housed in the first recess after its deformation by punching.

20. The assembly device of claim 3, wherein the male connector is held by the first wedge with play in the directions of the plane defined by the first face.

21. An assembly device for assembling a first module and a second module, the assembly device comprising:
a first wedge configured to be secured to the first module and having a first face, the first wedge comprising first cavities emerging from the first face;
a connection means configured to attach the first module to the second module;
a second wedge provided with a second face and comprising at least one first pin projecting from the second face, the at least one first pin having a size less than that of the first cavities; and
a glue bag arranged on a bottom of the first cavities that, under the effect of a bearing force exerted by the at least one first pin, when the first face and the second face are brought together, gives way and allows the glue contained therein to respond in the volume delimited by the first cavity in order to seal the first pin.
